(19) United States
(12) Patent Application Publication
(10) Pub. No.: US 2001/0047899 A1
(43) Pub. Date: Dec. 6, 2001

(54) INSTRUMENT PANEL STRUCTURE AND METHOD OF ASSEMBLING THE SAME

(76) Inventor: YUICHI IKEDA, NAGOYA-SHI (JP)

Correspondence Address: ROSSI & ASSOCIATES, P.O. BOX 826, ASBURN, VA, 201460826

(21) Appl. No.: 09/049,343

(22) Filed: Mar. 27, 1998

(30) Foreign Application Priority Data
Mar. 28, 1997 (JP) 9-77627

(51) Int. Cl. B62D 25/14; B60K 37/00

(52) U.S. Cl. 180/90; 296/70

(57) ABSTRACT

An instrument panel structure includes a base structural body secured to a vehicle body and having an enclosed space, an instrument panel provided on one side of the base structural body that faces the vehicle compartment, and an air conditioning system disposed in the base structural body. The base structural body has a large cross section and defines a large space so that the air conditioning system including a heater core, evaporator, blower and others can be located inside the base structural body, assuring sufficiently high rigidity without increasing the weight and cost.

### FIELD OF THE INVENTION

The present invention relates to an instrument panel structure wherein a base structural body, having an enclosed space, is attached to the rear surface of an instrument panel, and to a method of assembling such an instrument panel structure.

### BACKGROUND OF THE INVENTION

An instrument panel structure of a motor vehicle is generally provided with an air conditioning system, ducts, electric equipment, such as meters, and other equipment or accessories, such as an air bag module. In addition, a steering shaft is also attached to the instrument panel structure. Thus, various attempts have been made to ensure sufficiently high rigidity of the instrument panel structure, while taking into account of weight, manufacturing costs, and other factors.

In an instrument panel structure as disclosed in U.S. Pat. Nos. 5,549,344, 5,678,877, and 5,685,595, for example, a substrate that extends over the entire width of the vehicle body is disposed within a space formed by an instrument panel, and a plurality of ducts are formed integrally with the substrate. The substrate includes mounting portions on which electric equipment, other equipment and wire harness are mounted. In this arrangement, the substrate with the ducts formed as integral parts may be commonly used for various types of vehicles, and the rigidity of the instrument panel can be improved.

Although the rigidity of the instrument panel is improved to a certain extent due to provision of the substrate in the known instrument panel structure, the instrument panel still exhibits insufficient torsional rigidity or rigidity against input stresses applied to its side faces. In view of this problem, the known instrument panel structure includes a reinforcing member, such as a deck cross member, for providing sufficiently high rigidity against various kinds of input stresses, but the provision of the reinforcing member results in an increase in the weight of the panel structure. Further, a space particularly used for mounting such equipment as an air conditioning system needs to be provided separately from the instrument panel structure. Thus, the known instrument panel structure has increased weight and requires large space for installation, and is thus available at increased cost.

### SUMMARY OF THE INVENTION

The present invention has been developed in the light of the above-described situations. It is therefore a first object of the present invention to provide an instrument panel structure which assures sufficiently high rigidity against various kinds of inputs, without increasing the weight and cost. It is a second object of the invention to provide a method of assembling such an instrument panel structure.

The first object may be accomplished according to the first aspect of the present invention, which provides an instrument panel structure for a motor vehicle comprising: a base structural body which is secured to a vehicle body, the base structural body having an enclosed space; an instrument panel provided on one side of the base structural body which faces a vehicle compartment; and an air conditioning system located inside the base structural body

In the instrument panel structure constructed as described above, the base structural body consists of a hollow member having an enclosed space in which the air conditioning system is installed. Thus, the base structural body provides a large cross section, which leads to increased rigidity of the instrument panel structure. Since the air conditioning system is located within the base structural body, no additional space is needed for installing the air conditioning system.

The second object may be accomplished according to the second aspect of the present invention, which provides a method of assembling an instrument panel structure, comprising the steps of: securing a base structural body having an enclosed space to a vehicle body; attaching an instrument panel to a first side of the base structural body which faces a vehicle compartment; and installing an air conditioning system within the base structural body.

The instrumental panel structure fabricated according to this method has the same advantageous features as described above with respect to the first aspect of the invention.

### BRIEF DESCRIPTION OF THE DRAWINGS

FIG. 1 is an exploded perspective view of an instrument panel structure according to one embodiment of the present invention.

FIG. 2 is a cross-sectional view taken along line II-II of FIG. 1;

FIG. 3 is a cross-sectional view taken along line III-III of FIG. 1;

FIG. 4 is a cross-sectional view taken along line IV-IV of FIG. 1;

FIG. 5 is a perspective view showing a bracket as one element of the instrument panel structure of FIG. 1; and

FIG. 6 is a cross-sectional view of an instrumental panel structure according to another embodiment of the present invention

### DETAILED DESCRIPTION OF THE PREFERRED EMBODIMENTS

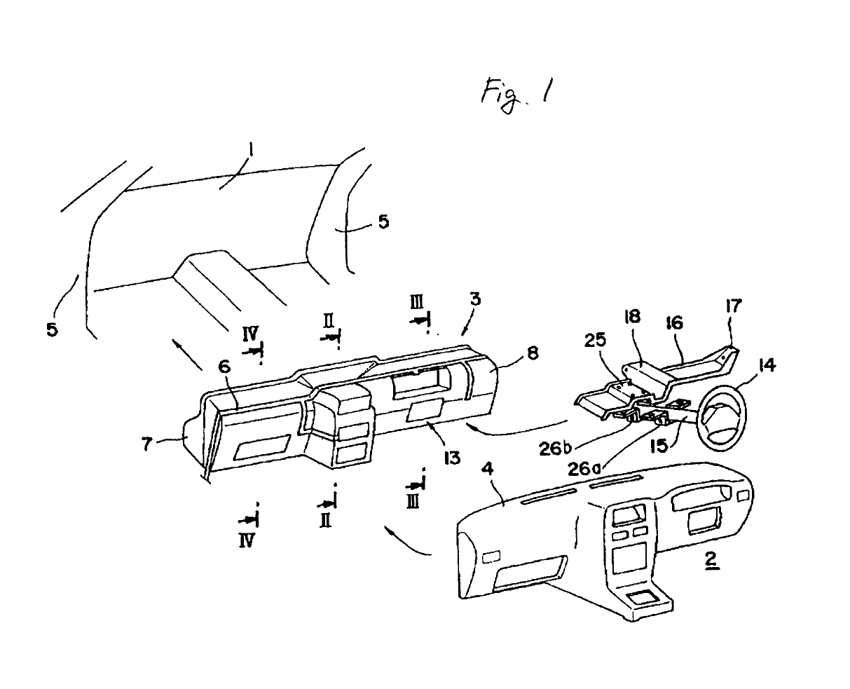

Referring first to FIG. 1, a base structural body 3 which consists of a resin structure having an enclosed space is provided on one side of a dash panel 1 of a vehicle body that faces a vehicle compartment 2. An instrument panel 4 that provides a cover member is mounted on the front face (on the side of the vehicle compartment 2) of the base structural body 3. The base structural body 3 is fixed at its opposite ends to pillars 5, 5 that provide side walls of the vehicle body, and a wire member 6 used for wiring of electrical equipment and meters is arranged over the surface of the base structural body 3 such that the wire member 6 and the base structural body 3 are formed integrally with each other.

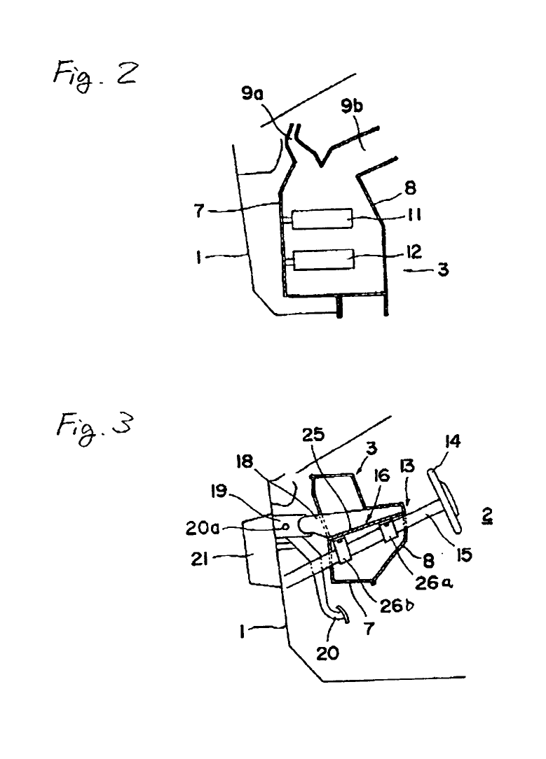

As shown in FIG. 2 through FIG. 4, the base structural body 3 consists of a back panel 7 (on the front side of the vehicle; left side in FIGS. 2-4), and a front panel 8 (on the side of the vehicle compartment 2; right side in FIGS. 2-4). The back panel 7 and the front panel 8 are fastened to each other by screws, or the like, and joined together into an integral body. The base structural body 3 is formed integrally with ducts for guiding or conveying the air toward defroster nozzles 9a and blowoff ports 9b. The back panel 7 and the front panel 8 may be formed, for example, by pressing a resin sheet containing glass, or by injection molding.

The base structural body 3 may be constructed such that separate members for defining ducts are attached to the structural body 3, or such that the back panel 7 and the front panel 8 are formed into an integral body. Also, all of the back panel 7, front panel 8 and ducts may be formed as an integral structure.

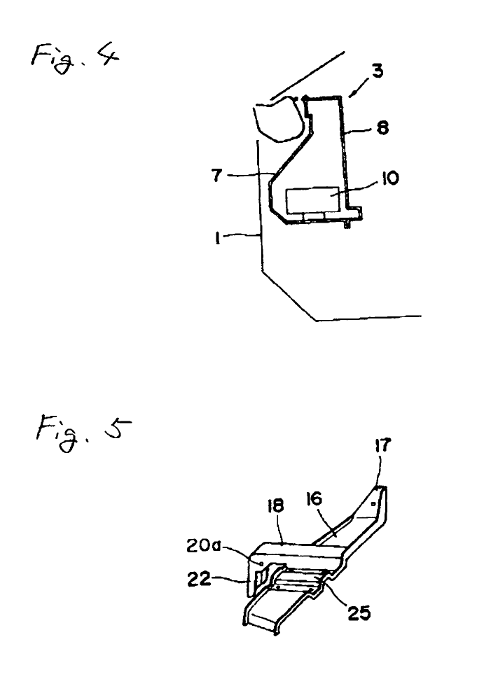

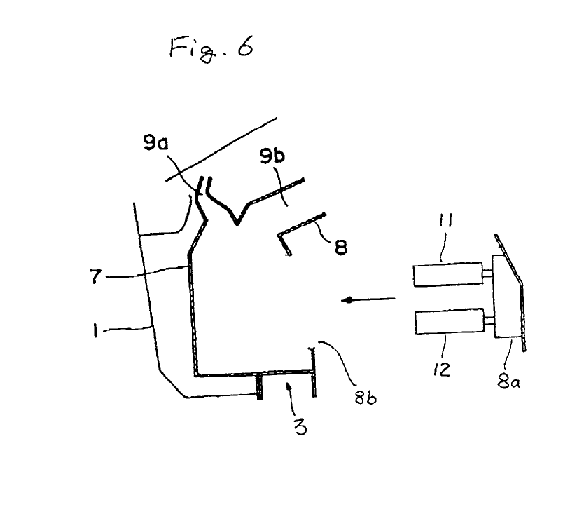

As shown in FIG. 2, the base structural body 3 has an enclosed space in which an air conditioning system can be housed. More specifically, a heater core 7 and an evaporator 12 are disposed inside the base structural body 3 consisting of the back panel 7 and the front panel 8, such that heater core 11 and the evaporator 12 are fixed to the inner wall of the back panel 7 to thus provide the air conditioning system. As shown in FIG. 4, a blower 10 is disposed inside the base structural body 3 on the passenger's side of the vehicle. This blower 10 serves to deliver air, which passes through the air conditioning system so that its temperature is controlled to a certain level, and then flows through the defroster nozzles 9a and blowoff ports 9b.

Where the integrally formed structure of the back panel 7 and the front panel 8, or the integrally formed structure of the back panel 7, front panel 8 and ducts 9, is used as the base structural body 3, the heater core 11 and the evaporator 12 are fixed to a support member 8a, as shown in FIG. 6, and this support member 8a is fitted in an opening 8b of the base structural body 3 so that the heater core 11 and the evaporator 12 are located inside the base structural body 3. Owing to the use of the support member 8a, the maintenance of the heater core 11 and the evaporator 12 can be conducted without disassembling the base structural body 3.

Even in the case where the base structural 3 consists of the back panel 7 and the front panel 8 as separate members as shown in FIG. 2, a support member may be used for mounting the heater core 11 and the evaporator 12 in the inside of the base structural body 3.

In the instrument panel structure as described above, the base structural body 3 is constructed by forming the back panel 7 and the front panel 8 integrally with each other, and the heater core 11 and the evaporator 12 that constitute the air conditioning system are installed inside the base structural body 3. In this arrangement, the cross section of the base structural body 3 that defines a closed space can be increased, and its rigidity is accordingly enhanced. Thus, the instrument panel structure of the present invention assures sufficiently high degrees of torsional rigidity and rigidity against input stresses applied to its side faces, without using a deck cross member. Moreover, this arrangement eliminates a need to provide a space exclusively used for installation of the air conditioning system.

Furthermore, there is no need to provide an air conditioner case, a blower case, and the ducts as separate members in addition to the base structural body 3, and leakage of the air can be prevented in the above structure in which the ducts and air conditioning system are formed as a unit. This leads to space saving or improved packaging efficiency, and prevents the air conditioning system and a dash panel from interfering with each other. Moreover, the amount of protrusion of a steering wheel into the vehicle compartment can be reduced.

Referring to FIG. 1 through FIG. 3, there will be next described a structure for supporting a steering shaft in the instrument panel structure including the base structural body 3.

The base structural body 3 includes a column support portion 13 on the side of the driver's seat, and a steering column 15 is attached to this column support portion 13 such that a steering shaft connected to a steering wheel 14 is rotatably supported by the steering column 15 More specifically, a bracket member 16 in the form of a sheet metal or die-cast aluminum, for example, is provided at the column support portion 13 in the lower part of the base structural body 3, and the steering column is attached to mounting members 26a, 26b which are fixed to a column mount member 25 of the bracket member 16.

The bracket member 16 extends in the vehicle width direction, and its one side portion (one end) is fixed to a corresponding one of the pillars 5 while the other end is bent downward along the shape of the base structural body 3. The bracket member 16 also includes a central portion 18 which extends toward the front side of the vehicle, and the distal end of the central portion 18 is attached to a pedal bracket 19 that is secured to the dash panel 1 of the vehicle body. The central portion 18 is located adjacent to the column mount portion 25. A brake pedal 20 is supported by the pedal bracket 19 via a pedal pivot shaft 20a such that the pedal 20 is pivotable about the pedal pivot shaft 20a. In FIG. 3, reference numeral 21 denotes a brake booster of a brake device of the vehicle.

The bracket member 16 may be further extended such that the above-indicated other end, which is bent downward, reaches the floor of the vehicle compartment and is fixed to a structure that provides the floor. As shown in FIG. 5, the central portion 18 may be formed with a flange portion 22 which is directly attached or fixed to the dash panel 1 of the vehicle, and the pedal pivot shaft 20a may be provided at the flange portion 22 so as to support the brake pedal 20.

In the structure for supporting the steering shaft as described above, the steering column 15 is supported by the bracket member 16 whose one end 17 is secured to the pillar 5, and whose central portion 18 adjacent to the column mount portion 25 is fixed to the dash panel 1 via the pedal bracket 19. Accordingly, the bracket member 16 provides sufficiently high supporting capability (rigidity) without increasing weight. When used along with the base structural body 3 having an increased cross-sectional area and improved rigidity, the bracket member 16 having high rigidity is able to support the steering column 15 with improved reliability, without increasing the weight and cost of the overall instrument panel structure. In the arrangement of FIG. 5 wherein the flange portion 22 formed at the distal end of the central portion 18 of the bracket member 16 is directly attached to the dash panel 1 of the vehicle body, and the pedal pivot shaft 20a is provided at the flange portion 22 for supporting the brake pedal 20, the number of components can be reduced by eliminating the pedal bracket 19.

In the instrument panel structure of the present invention, the air conditioning system is accommodated or installed within the structural member having an enclosed space, and therefore the cross-sectional area of this structural member can be increased, thereby assuring improved rigidity. Thus, the instrument panel structure of the invention assures sufficiently high rigidity against various kinds of input stresses without using a reinforming member, such as a deck cross member, which would otherwise increase the weight and cost of the overall structure.

Moreover, there is no need to provide a space exclusively used for installing the air conditioning system, which leads to space saving and prevents the air conditioning system and the dash panel from interfering with each other during collision of the vehicle. Further, leakage of the air can be avoided since the entire air conditioning system is located inside the base structural body. Furthermore, the amount of protrusion of the steering wheel into the vehicle compartment can be reduced.

What is claimed is:

1. An instrument panel structure for a motor vehicle, comprising:
a base structural body which is secured to a vehicle body, said base structural body including an enclosed space;
an instrument panel provided on a first side of said base structural body, said first side facing a vehicle compartment; and
an air conditioning system disposed inside said base structural body.

2. An instrument panel structure according to claim 1, wherein said base structural body is secured at opposite ends thereof as viewed in a vehicle width direction, to respective members that provide opposite side walls of the vehicle body.

3. An instrument panel structure according to claim 1, wherein said base structural body comprises a front panel and a back panel.

4. An instrument panel structure according to claim 3, wherein said front panel and said back panel are formed as an integral body.

5. An instrument panel structure according to claim 1, wherein said base structural body includes at least one duct which guides the air generated from said air conditioning system.

6. An instrument panel structure according to claim 1, wherein said air conditioning system comprises a blower.

7. An instrument panel structure according to claim 1, wherein said air conditioning system comprises a heater core.

8. An instrument panel structure according to claim 1, wherein said air conditioning system comprises an evaporator.

9. An instrument panel structure according to claim 1, further comprising a support member for supporting said air conditioning system, said air conditioning system being secured to said base structural body via said support member.

10. An instrument panel structure according to claim 9, wherein said base structural body has an opening through which said air conditioning system is inserted into the base structural body, said opening being closed by said support member.

11. An instrument panel structure according to claim 10, further comprising a bracket for supporting a steering column, said bracket being secured to said base structural body on the side of a driver's seat.

12. An instrument panel structure according to claim 11, wherein said bracket is secured to a member that constitutes a side wall of the vehicle body.

13. An instrument panel structure according to claim 11, further comprising a dash panel provided on a second side of said base structural body remote from the vehicle compartment, wherein said bracket is secured to said dash panel.

14. An instrument panel structure according to claim 13, further comprising a pedal bracket which supports a pedal for controlling running of the vehicle, said bracket being secured to said dash panel via said pedal bracket.

15. An instrument panel structure according to claim 13, wherein said bracket includes a pedal support shaft which supports a pedal for controlling running of the vehicle such that the pedal is pivotable about the pedal support shaft.

16. An instrument panel structure according to claim 11, wherein said bracket is secured to a member which constitutes a floor of the vehicle body.

17. An instrument panel structure according to claim 1, wherein said base structural body is formed from a resin seat containing glass.

18. A method of assembling an instrument panel structure, comprising the steps of:
securing a base structural body including an enclosed space to a vehicle body;
attaching an instrument panel to a first side of the base structural body which faces a vehicle compartment; and
installing an air conditioning system within the base structural body.

19. A method according to claim 18, further comprising a step of securing opposite ends of said base structural body as viewed in a vehicle width direction, to respective members that provide opposite side walls of the vehicle body.

20. A method according to claim 18, further comprising a step of forming a front panel and a back panel integrally with each other to provide the base structural body.

21. A method according to claim 18, further comprising a step of securing a bracket for supporting a steering column, to said base structural body on the side of a driver's seat.

22. A method according to claim 21, further comprising a step of securing said bracket to a member that constitutes a side wall of the vehicle body.

23. A method according to claim 21, further comprising a step of providing a dash panel on a second side of the base structural body remote from the vehicle compartment, and a step of securing said bracket to the dash panel.
